(19) United States
(12) Patent Application Publication
(10) Pub. No.: US 2012/0110335 A1
(43) Pub. Date: May 3, 2012

(54) Secure Association of Metadata with Content

(75) Inventors: Leonid Sandler, Jerusalem (IL); Yossi Tsuria, Jerusalem (IL)

(73) Assignee: NDS Limited, Staines, Middlesex (GB)

(21) Appl. No.: 13/322,737

(22) PCT Filed: May 13, 2010
(86) PCT No.: PCT/IB2010/052136

§ 371 Date: Dec. 23, 2011

Related U.S. Application Data
(60) Provisional application No. 61/268,152, filed on Jun. 8, 2009.

(51) Int. Cl. H04L 9/32

(52) U.S. Cl. 713/176; 713/150

(57) ABSTRACT

A method and system for associating metadata with an encrypted content item, the method including receiving metadata for association with a content item, receiving an entitlement control packet (ECP) associated with the content item, applying a cryptographic hash function to the ECP, thereby generating an ECP hash value, combining the ECP hash value with the metadata, thereby creating a data control object, performing a cryptographic operation on the data control object, thereby generating cryptographic integrity data, and joining the cryptographic integrity data to the data control object after the cryptographic operation, wherein usage of the content by the recipient is dependent on both a validation of the ECP hash value and a validation of the cryptographic integrity data. Related apparatus and methods are also described.

### RELATED APPLICATION INFORMATION

The present application claims the benefit of priority from U.S. provisional application No. 61/268,152 of Leonid Sandler, et al., filed 8 Jun. 2009, the disclosure of which is hereby incorporated herein by reference.

### BACKGROUND OF THE INVENTION

The following standards are considered particularly relevant to the present invention:

Digital Video Broadcast (DVB); Support for Use of Scrambling and Conditional Access (CA) within Digital Broadcasting Systems, October 1996, ETR 289;

Information Technology—Generic Coding of Moving Pictures and Associated Audio Information: Systems, December 2000, ISO/IEC 13818-1;

OpenCable Application Platform Specifications, OCAP 1.1 Profile, August 2008, OC-SP-OCAP1.1-D02-080807; and

OpenCable Specifications, Cab1eCARD 2.0 Interface Specification, February, 2009, OC-SP-CCIF2.0-I17-090206;

OC-SP-OCAP1.1-D02-080807; OC-SP-CCIF2.0-I17-090206; ETR 289; and ISO/IEC 13818-1 are hereby incorporated by reference.

The SHA-1 and SHA-2 hash algorithms (collectively including all of: SHA-224; SHA-256; SHA-384; and SHA-512) are specified in FIPS 180.

A list of SHA-3 hash algorithm candidates is found at: csrc.nist.gov/groups/ST/hash/sha-3/Round1/submissions_rnd1.html.

The following references, listed by publication number, are believed to reflect the current state of the art:

EP 1732005 of NEC Corporation;

WO2008/060388 of Time Warner Cable, Inc.;

US 2008/0123845 of Candelore;

US 2008/012386 of Candelore; and

US 2008/183656 of Perng, et al.

### SUMMARY OF THE INVENTION

There is thus provided in accordance with an embodiment of the present invention a method for associating metadata with an encrypted content item, the method including receiving metadata for association with a content item, receiving an entitlement control packet (ECP) associated with the content item, applying a cryptographic hash function to the ECP, thereby generating an ECP hash value, combining the ECP hash value with the metadata, thereby creating a data control object, performing a cryptographic operation on the data control object, thereby generating cryptographic integrity data, and joining the cryptographic integrity data to the data control object after the cryptographic operation, wherein usage of the content by the recipient is dependent on both a validation of the ECP hash value and a validation of the cryptographic integrity data.

Further in accordance with an embodiment of the present invention the ECP includes one of an entitlement control message (ECM), and a digital rights management (DRM) content license.

Still further in accordance with an embodiment of the present invention and including sending the cryptographically associated data control object joined to the cryptographic integrity data to a recipient.

Additionally in accordance with an embodiment of the present invention the sending includes sending in-band sending.

Moreover in accordance with an embodiment of the present invention the sending includes out-of-band sending.

Further in accordance with an embodiment of the present invention the metadata includes service information.

Still further in accordance with an embodiment of the present invention the metadata includes a usage rule governing the usage of the content item.

Additionally in accordance with an embodiment of the present invention the cryptographically associating the combined ECP hash value and the metadata which include the data control object includes digitally signing the data control object, thereby generating a digital signature.

Moreover in accordance with an embodiment of the present invention the joined cryptographic integrity data includes the digital signature.

Further in accordance with an embodiment of the present invention the cryptographically associating the data control object includes encrypting the data control object according to a key, the key including a secret shared with the recipient.

Still further in accordance with an embodiment of the present invention the joined cryptographic integrity data includes a reference to the secret shared with the recipient.

Additionally in accordance with an embodiment of the present invention the cryptographic hash function includes one of SHA-1, SHA-2, and a SHA-3 candidate function.

There is also provided in accordance with another embodiment of the present invention a method for content utilization, the method including receiving an encrypted content item, receiving an entitlement control message (ECP) associated with the encrypted content item, receiving a data control object, the data control object including an ECP hash value, metadata, and cryptographic integrity data, using the cryptographic integrity data to cryptographically verify the integrity of the data control object, applying a cryptographic hash function to the received ECP, thereby generating a second ECP hash value, comparing the second ECP hash value with the received ECP hash value, and performing metadata processing if the result of the comparing is positive, thereby assuring the metadata cryptographically corresponds to the content item.

Further in accordance with an embodiment of the present invention the ECP includes one of an entitlement control message (ECM), and a digital rights management (DRM) content license.

Still further in accordance with an embodiment of the present invention the receiving the data control object includes in-band receiving.

Additionally in accordance with an embodiment of the present invention the receiving the data control object includes out-of-band receiving.

Moreover in accordance with an embodiment of the present invention the metadata includes service information.

Further in accordance with an embodiment of the present invention the metadata includes a usage rule governing the usage of the content item.

Still further in accordance with an embodiment of the present invention the ECP hash value and the metadata included in the data control object have been digitally signed.

Additionally in accordance with an embodiment of the present invention the cryptographic integrity data includes the digital signature of the ECP hash value and the metadata.

Moreover in accordance with an embodiment of the present invention the ECP hash value and the metadata included in the data control object have been encrypted.

Further in accordance with an embodiment of the present invention the encrypted ECP hash value and the metadata have been encrypted according to a key, the key including a secret shared with the sender of the received data control object.

Still further in accordance with an embodiment of the present invention the cryptographic integrity data includes a reference to the shared secret.

Additionally in accordance with an embodiment of the present invention the using the cryptographic integrity data to cryptographically verify the ECP hash value and the metadata includes using the key to decrypt the encrypted ECP hash value and metadata.

Moreover in accordance with an embodiment of the present invention the cryptographic hash function includes one of SHA-1, SHA-2, and SHA-3 candidate function.

There is also provided in accordance with still another embodiment of the present invention a system for associating metadata with an encrypted content item, the system including a metadata receiver operative to receive metadata for association with a content item, an entitlement control packet (ECP) receiver operative to receive an ECP associated with the content item, a cryptographic engine operative to apply a cryptographic hash function to the ECP, thereby generating an ECP hash value, a processor operative to combine the ECP hash value with the metadata, thereby creating a data control object, a second cryptographic engine which performs a cryptographic operation on the data control object, thereby generating cryptographic integrity data, and a second processor which joins the cryptographic integrity data to the data control object after the cryptographic operation, wherein usage of the content by the recipient is dependent on both a validation of the ECP hash value and a validation of the cryptographic integrity data.

There is also provided in accordance with still another embodiment of the present invention a system for content utilization, the system including a content receiver operative to receive an encrypted content item, an entitlement control packet (ECP) receiver operative to receive an ECP associated with the encrypted content item, a data control object receiver operative to receive a data control object, the data control object including an ECP hash value, metadata, and cryptographic integrity data, a cryptographic engine operative to use the cryptographic integrity data to cryptographically verify the integrity of the data control object, a second cryptographic engine operative to apply a cryptographic hash function to the received ECP, thereby generating a second ECP hash value, a comparing processor operative to compare the second ECP hash value with the received ECP hash value, and a metadata processor operative to perform metadata processing if the result of the comparing is positive, thereby assuring the metadata cryptographically corresponds to the content item.

### BRIEF DESCRIPTION OF THE DRAWINGS

The present invention will be understood and appreciated more fully from the following detailed description, taken in conjunction with the drawings in which:

FIGS. 1A and 1B, taken together, are a simplified block diagram of data flow in a content distribution system, in which encrypted content and metadata associated with the encrypted content are depicted, the content distribution system constructed and operative in accordance with an embodiment of the present invention;

FIG. 2 is a simplified block diagram depicting production, during secure stream generation, of a secure metadata object in the system of FIGS. 1A and 1B;

FIG. 3A is a simplified block diagram of a first embodiment of a secure metadata object of FIGS. 1A and 1B;

FIG. 3B is a simplified block diagram of a second embodiment of the secure metadata object of FIGS. 1A and 1B;

FIG. 4 is a simplified block diagram depicting, at a consumer device, an evaluation of the secure metadata object in the system of FIGS. 1A and 1B; and

FIGS. 5-6 are simplified flowcharts of preferred methods of operation of the system of FIG. 1.

### DETAILED DESCRIPTION OF AN EMBODIMENT

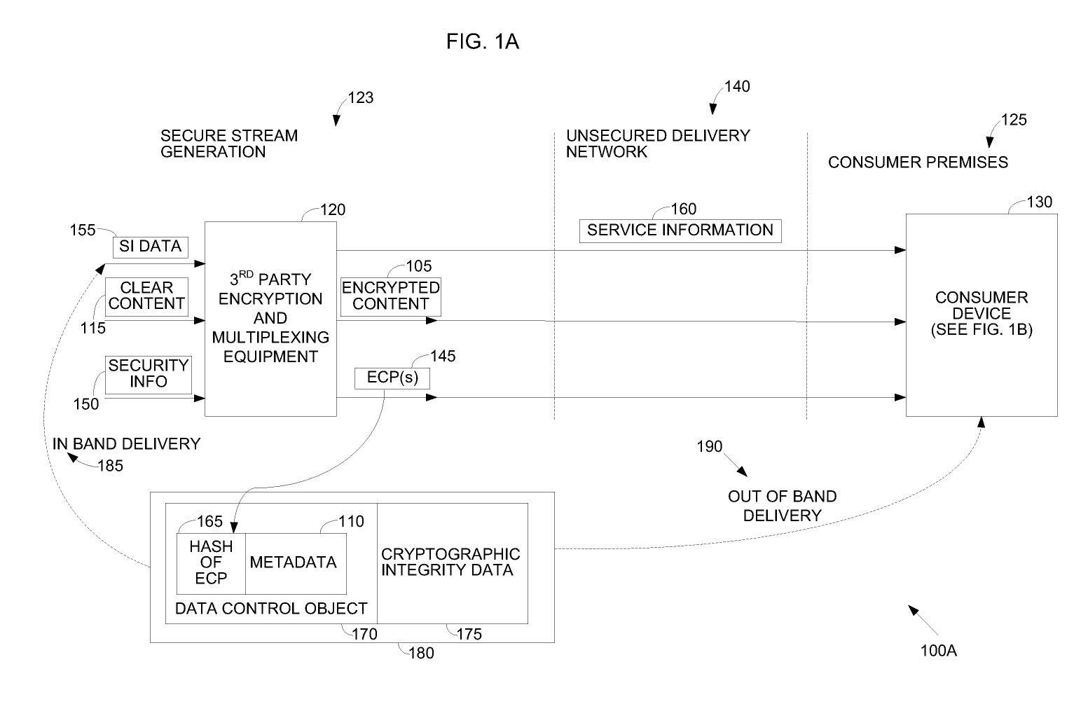

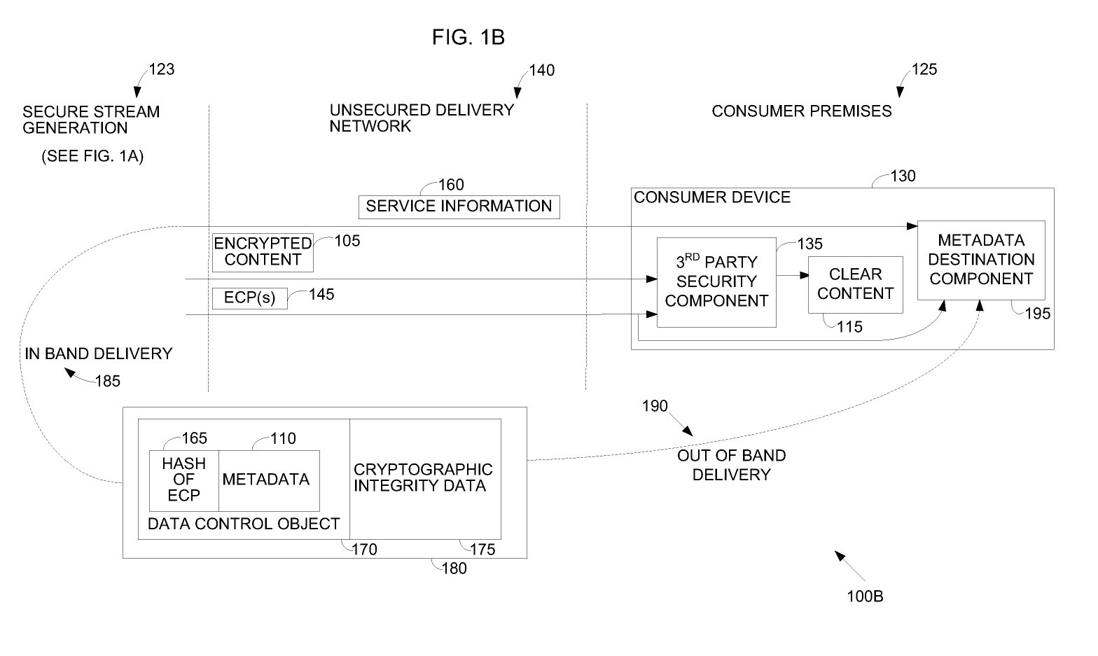

Reference is now made to FIGS. 1A and 1B, which, taken together, are a simplified block diagram of data flow in a content distribution system 100A, 100B, in which encrypted content 105 and metadata 110 associated with the encrypted content 105 are depicted, the content distribution system 100A, 100B constructed and operative in accordance with an embodiment of the present invention. Those skilled in the art will appreciate that the metadata 110 is generated outside of the content distribution system 100A, 100B.

Throughout the present specification and claims the term “metadata” is used for ease of description. However, any appropriate cryptographic equivalent of the metadata may be used in the methods and systems described herein.

Content protection systems are typically based on encryption of the clear content 115. As is well known in the art, encryption of the clear content 115 is according to secret keys (not depicted), also known as control words. The keys are delivered separately to a consumer device 130 in some form of entitlement control packets (ECPs). For example and without limiting the generality of the foregoing, ECPs 145 may comprise Entitlement Control Messages (ECMs) defined by the MPEG2 System standard (ISO/IEC 13818-1, referred to above), or, alternatively, so called “content licenses” used in various DRM (digital rights management) systems.

Those skilled in the art will appreciate that each individual ECP 145 is uniquely associated with at least one portion of the encrypted content 105. For example, one crypto-period (a crypto period is the time span during which a specific cryptographic key (control word) is intended for use.). For example and without limiting the generality of the foregoing, if the individual ECP 145 comprises an ECM, then the ECM is required by the consumer device 130 in order to produce a control word enabling decryption of the a first portion of encrypted content 105 for one crypto-period. A second ECM is required by the consumer device 130 in order to produce a control word enabling decryption of a second portion of encrypted content for the next crypto-period, and so forth for each ensuing crypto-period.

In some cases it is necessary to provide additional information to the consumer device 130 (hereinafter, “metadata” 110), as explained below. The metadata 110, in such cases, is often cryptographically associated with such encrypted content 105. Further, it is often the case that any underlying content protection system cannot be utilized or modified in order to cryptographically associate the metadata 110 with the encrypted content 105. For example and without limiting the generality of the foregoing, clear content 115 (the term “clear”, as used herein, as in, “clear content”, is used to mean not encrypted; that is to say, clear content is content which is not encrypted) may be encrypted using a 3^{rd} party system 120. As a non-limiting example of a typical 3^{rd} party system 120, the 3^{rd} party system 120 would comprise an MPEG2 compliant encryption and multiplexing 3^{rd} party system 120. The 3^{rd} party system 120, which is operative during secure stream generation 123 typically further comprises components of a conditional access (CA) system. Decryption of the encrypted content 105 is performed on consumer premises 125 in the consumer device 130 comprising by a 3^{rd} party security component 135 such as CableCard (see, for instance, OC-SP-CCIF2.0-I17-090206 and OC-SP-OCAP1.1-D02-080807, referred to above).

Typically, the 3^{rd} party security component 135, such as the CableCard, comprises an interface which cannot be modified or extended for the purposes of metadata insertion. However, other components in the consumer device 130 may require metadata 110 related, for example, to usage rules of the encrypted content 105 in a home network environment. Such metadata 110 must be securely associated with the content 105. If the metadata 110 is not securely associated with the content 105, there is a chance that decoupling between the content 105 and the metadata 110 may occur, particularly while the content is in an unsecured delivery network 140 during delivery to the consumer premises 125. Alternatively, decoupling between the content 105 and the metadata 110 may occur at a later time at the consumer premises 125.

One method of the present invention allows secure association of any kind of metadata 110 with the encrypted content 105 in any environment or system wherein the encrypted content 105 is already associated with any form of entitlement control packets 145. It is appreciated that the method of the present invention described herein enables performing the association of the encrypted content 105 with the metadata 110 without any understanding of the entitlement control packets 145 and without any cooperation from the owner of the entitlement control packets 145.

Those skilled in the art will appreciate that the method of the present invention described herein that establishes a cryptographic association between metadata 110 and the ECP 145 is cryptographically identical to the cryptographic association between the metadata 110 and the encrypted content 105 itself.

The operation of the system of FIGS. 1A and 1B is now described. Clear content 115 is input into the 3^{rd} party system 120. It is appreciated that the description of the encryption and multiplexing system 120 herein as an MPEG2 compliant encryption and multiplexing system 120 is by way of example only, and is not meant to be limiting. The 3^{rd} party system 120 encrypts the clear content 115 and outputs the encrypted content 105. Security information 150 is also input into the 3^{rd} party system 120. The 3^{rd} party system 120 processes the input security information 150, and outputs ECPs 145. In addition, service information (SI) related data 155 is input into the 3^{rd} party system 120 and Service Information (SI) 160 is output.

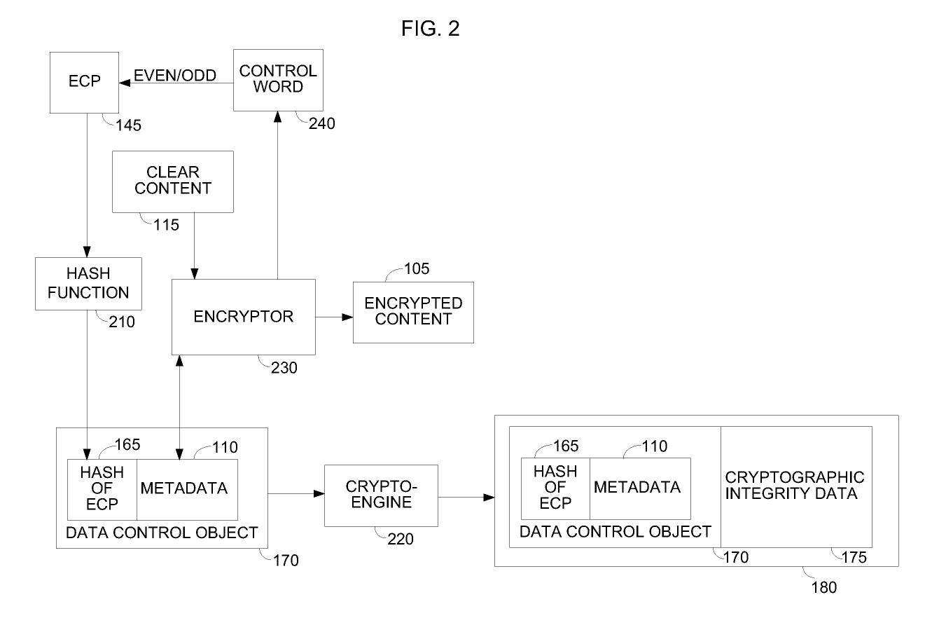

Reference is now additionally made to FIG. 2, which is a simplified block diagram depicting production, during secure stream generation, of a secure metadata object 180 in the system of FIGS. 1A and 1B. Each individual ECP 145 is input into a cryptographic hash function 210. Any appropriate cryptographic hash function may be used, such as, example and without limiting the generality of the foregoing, SHA-1; SHA-2 (collectively including all of: SHA-224; SHA-256; SHA-384; and SHA-512); and various SHA-3 candidates. SHA-1 and SHA-2 are specified in FIPS 180. A list of SHA-3 candidates is found, at the time the present application was drafted, at: csrc.nist.gov/groups/ST/hash/sha-3/Round1/submissions_rnd1.html. The hash function 210 produces a hash 165 of the ECP 145.

The hash 165 of the ECP 145 is combined with the metadata 110, thereby producing a data control object 170. A crypto-engine 220 cryptographically associates the combined ECP hash 165 value and the metadata 110 which comprise the data control object 170, thereby generating cryptographic integrity data 175. The cryptographic integrity data 175 is joined to the data control object 170, thereby producing the secure metadata object 180. The secure metadata object 180 then sent to the consumer device 130. The nature of the joining of the cryptographic integrity data 175 to the data control object 170 is detailed below.

Throughout the present specification and claims the term “data control object 170” is used for ease of description. However, any appropriate cryptographic equivalent of the data control object 170 may be used in the methods and systems described herein.

The sending of the secure metadata object 180 to the consumer device 130 may be performed by any appropriate method known in the art for sending data between devices. For ease of depiction, FIGS. 1A and 1B depict an in-band delivery method 185, whereby the secure metadata object 180 is sent to the consumer device 130 comprised in the SI data 155, as a portion of the service information 160. Alternatively, where an out-of-band delivery channel 190 is operative, the secure metadata object 180 may be sent to the consumer device 130 as out-of-band data. Out-of-band delivery channels 190 are known in the art, and include, for example and without limiting the generality of the foregoing, IP communication.

Returning to the discussion of the ECP 145 of FIG. 2, an encryptor 230 receives the clear content 115 and, using a control word 240 as an encryption key, encrypts the clear content 115. The 3^{rd} party system 120 produces the ECP 145 for the control word 240, as is well know in the art.

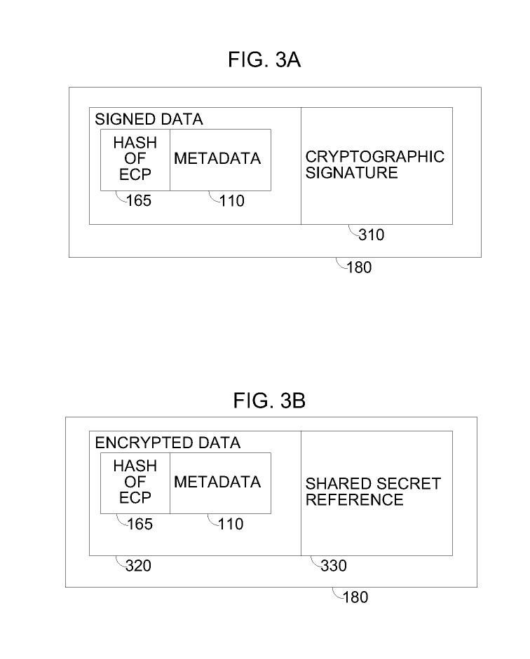

The nature of the secure metadata object 180 is now discussed. Reference is now additionally made to FIG. 3A, which is a simplified block diagram of the secure metadata object 180 of FIGS. 1A and 1B. In the first embodiment of the secure metadata object 180 of FIGS. 1A and 1B, after the ECP 145 is prepared by the 3^{rd} party system 120, a copy of the ECP 145 is input into a hash function 210, thereby producing the hash of the ECP 165. The hash of the ECP 165 is joined to the metadata 110, typically by concatenation of the hash of the ECP 165 and the metadata 110. The joined hash of the ECP 165 and metadata 110 are then cryptographically signed, thereby producing a cryptographic signature 310 of the joined hash of the ECP 165 and metadata 110. It is appreciated that the cryptographic signature 310 of FIG. 3A corresponds to the cryptographic integrity data 175 of FIGS. 1A and 1B. For example and without limiting the generality of the foregoing, the cryptographic signature 310 can be produced using any appropriate well known public key infrastructure (PKI) signature routine. Those skilled in the art will appreciate that the hash of the ECP 165 is used the present embodiment of the invention only for size optimization. In principle, the entire ECP 145 itself can be used as well in the present embodiment of the invention. The use of the cryptographically signed joined hash of the ECP 165 and metadata 110 in the consumer premises 125 is described below.

Reference is now additionally made to FIG. 3B, which is a simplified block diagram of a second embodiment of the secure metadata object 180 of FIGS. 1A and 1B. In the second embodiment of the data control object of FIGS. 1A and 1B, after the ECP 145 is prepared by the 3^{rd} party system 120, a copy of the ECP 145 is input into a hash function 210, thereby producing the hash of the ECP 165. The hash of the ECP 165 is joined to the metadata 110, typically by concatenation of the hash of the ECP 165 and the metadata 110. The joined hash of the ECP 165 and metadata 110 are then encrypted, thereby producing an encrypted data object 320 comprising the joined hash of the ECP 165 and metadata 110. For example and without limiting the generality of the foregoing, the encrypted data object 320 can be produced using any appropriate well known encryption algorithm, such as, but not limited to AES, 3DES, or Serpent. Those skilled in the art will appreciate that the hash of the ECP 165 is used the present embodiment of the invention only for size optimization. In principle, the entire ECP 145 itself can be used as well in the present embodiment of the invention. The use of the encrypted data object 320 in the consumer premises 125 is described below.

A reference 330 to a shared secret is appended to the encrypted data object 320 prior to sending the encrypted data object 320 to the consumer premises 125. The shared secret is a secret shared by the crypto-engine 220 and the consumer device 130. The encrypted data object 320 is typically encrypted using the actual shared secret as an encryption key.

It is appreciated that if the secure metadata object 180 is received at the consumer device 130 comprising the encrypted data object 320 comprising the joined hash of the ECP 165 and metadata 110, then the consumer device 130 will have to decrypt the encrypted data object 320 in order to access and validate the hash of the ECP 165 and metadata 110.

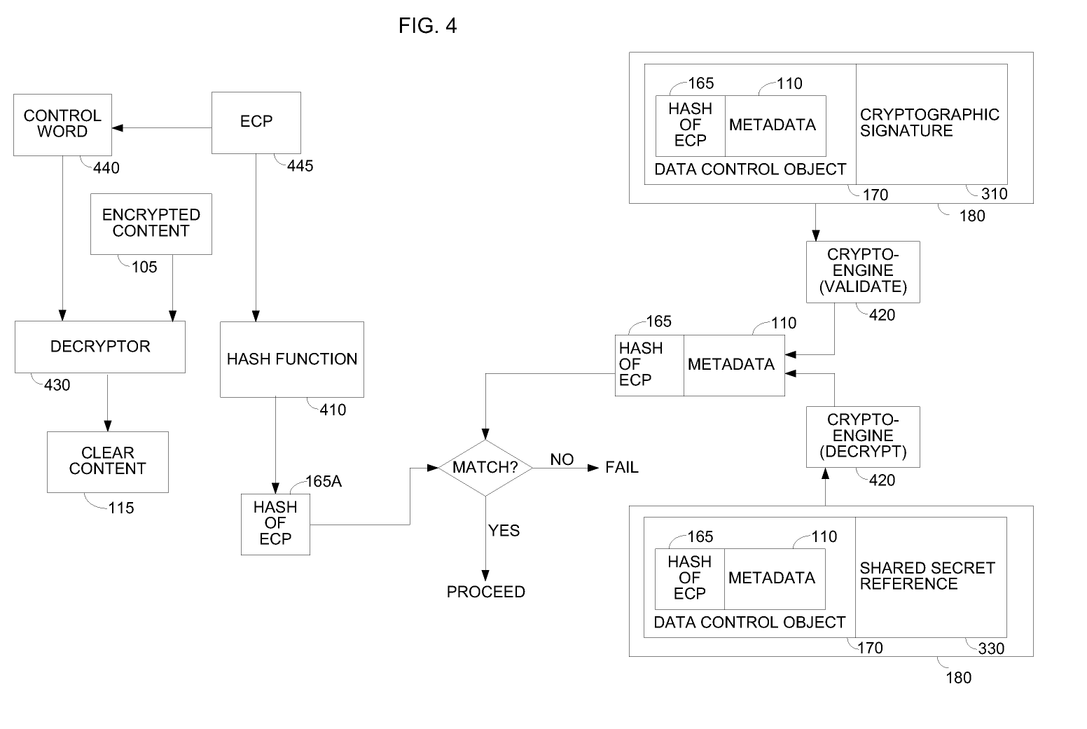

Returning to the discussion of FIG. 1B, reference is now additionally made to FIG. 4, which is a simplified block diagram depicting, at the consumer device 130, an evaluation of the secure metadata object 180 in the system of FIGS. 1A and 1B. The secure metadata object 180 is received at the consumer device 130. The following discussion relates to the two embodiments of the secure metadata object 180 described above with reference to FIGS. 3A and 3B, specifically: in the first embodiment, the data control object 170 is appended to a cryptographic signature 310; and in the second embodiment, the data control object 170 is appended to the reference 330 to a shared secret. Nonetheless, the embodiments described are not meant to be limiting and are brought in an exemplary fashion.

If the secure metadata object 180 is appended to the cryptographic signature 310, it is inputted into a crypto-engine 420 for validation. Alternatively, If the secure metadata object 180 is appended to the reference 330 to the shared secret, it is inputted into a crypto-engine 420 for decryption. In any event, the decrypted or validated data control object 170 separated to the metadata 110 and the hash of the ECP 165.

A received ECP 445 is input into a hash function 410, the hash function 410 being identical to the hash function 210 (FIG. 2) used during secure stream generation. A hash 165A of the ECP is output by the hash function 410. The hash 165A of the received ECP 445 is compared to the hash of the ECP 165 received in the secure metadata object 180.

If the two hashes, hash 165A of the received ECP 445 and the hash 165 of the ECP received in the secure metadata object 180 do not match, the comparison is determined to have failed. However, if the two hashes, hash 165A of the received ECP 445 and the hash 165 of the ECP received in the secure metadata object 180 do match, the comparison is determined to have succeeded.

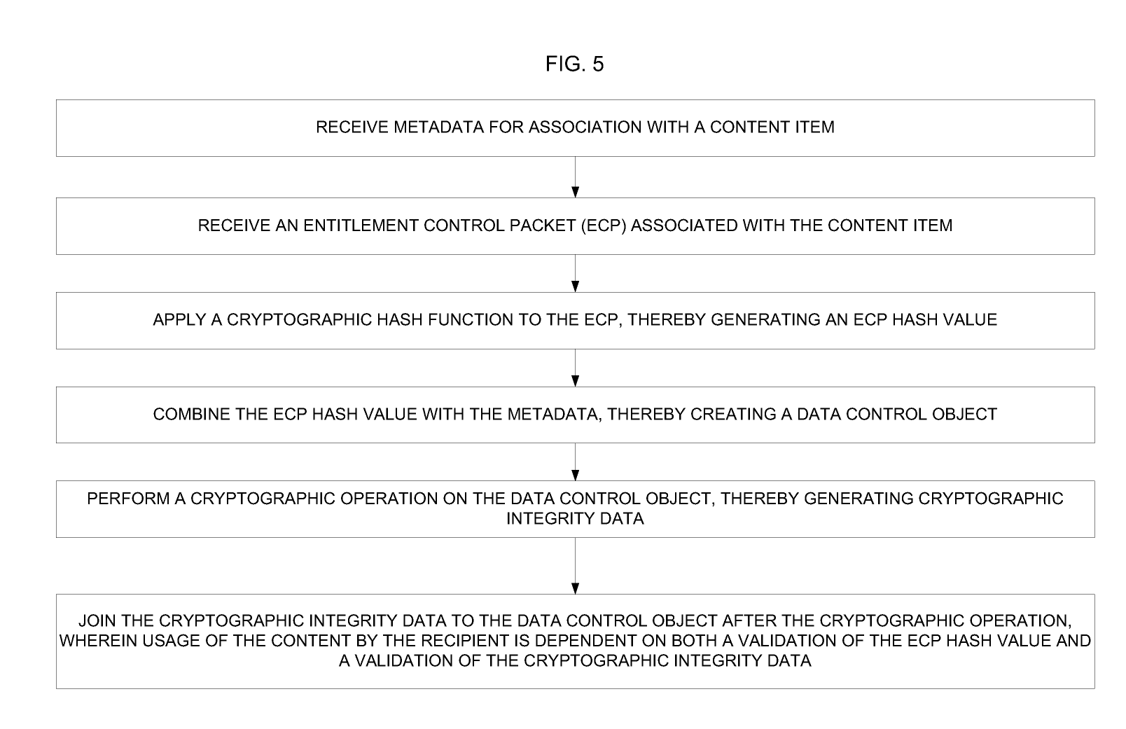

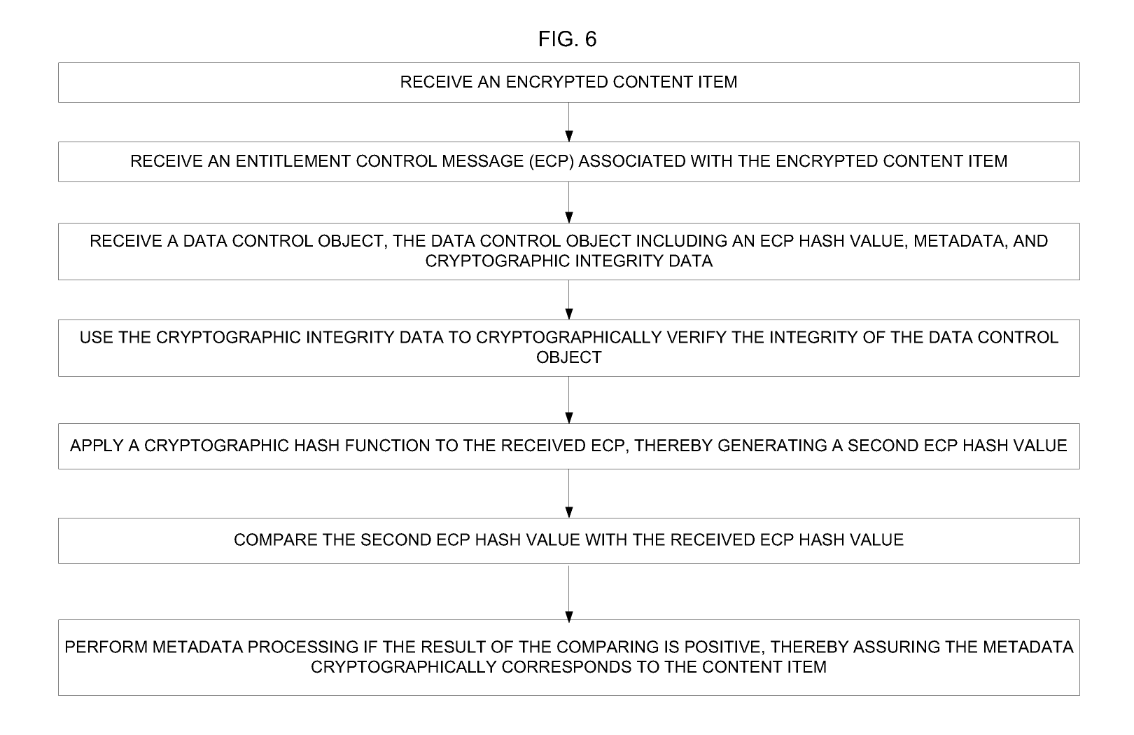

Reference is now made to FIGS. 5-6, which are simplified flowcharts of preferred methods of operation of the system of FIG. 1. FIGS. 5-6 are believed to be self-explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1. A method for associating metadata with an encrypted content item, the method comprising:
receiving metadata for association with a content item;
receiving an entitlement control packet (ECP) uniquely associated with at least one portion of the encrypted content item;
applying a cryptographic hash function to the ECP, thereby generating an ECP hash value;
combining the ECP hash value with the metadata, thereby creating a data control object;
performing a cryptographic operation on the data control object, thereby generating cryptographic integrity data; and
joining the cryptographic integrity data to the data control object after the cryptographic operation,

2. The method according to claim 1 and wherein the ECP comprises one of: an entitlement control message (ECM); and a digital rights management (DRM) content license.

3. The method according to claim 1 and further comprising sending the cryptographically associated data control object joined to the cryptographic integrity data to a recipient.

4. The method according to claim 3 and wherein the sending comprises sending in-band sending.

5. The method according to claim 3 and wherein the sending comprises out-of-band sending.

6. The method according to claim 1 and wherein the metadata comprises service information.

7. The method according to claim 1 and wherein the metadata comprises a usage rule governing the usage of the content item.

8. The method according to claim 1 and wherein the cryptographically associating the combined ECP hash value and the metadata which comprise the data control object comprises digitally signing the data control object, thereby generating a digital signature.

9. The method according to claim 8 and wherein the joined cryptographic integrity data comprises the digital signature.

10. The method according to claim 1 and wherein the cryptographically associating the data control object comprises encrypting the data control object according to a key, the key comprising a secret shared with the recipient.

11. The method according to claim 10 and wherein the joined cryptographic integrity data comprises a reference to the secret shared with the recipient.

12. The method according to any of claim 1 and wherein the cryptographic hash function comprises one of: SHA-1; SHA-2; and a SHA-3 candidate function.

13. A method for content utilization, the method comprising:
receiving an encrypted content item;
receiving an entitlement control message (ECP) uniquely associated with at least one portion of the encrypted content item;
receiving a data control object, the data control object comprising:
an ECP hash value;
metadata; and
cryptographic integrity data;
using the cryptographic integrity data to cryptographically verify the integrity of the data control object;
applying a cryptographic hash function to the received ECP, thereby generating a second ECP hash value;
comparing the second ECP hash value with the received ECP hash value; and
performing metadata processing if the result of the comparing is positive, thereby assuring the metadata cryptographically corresponds to the content item,
wherein usage of the content item by the recipient is dependent on both a validation of the ECP hash value and a validation of the cryptographic integrity data.

14. The method according to claim 13 and wherein the ECP comprises one of: an entitlement control message (ECM); and a digital rights management (DRM) content license.

15. The method according to claim 13 and wherein the receiving the data control object comprises in-band receiving.

16. The method according to claim 13 and wherein the receiving the data control object comprises out-of-band receiving.

17. The method according to claim 13 and wherein the metadata comprises service information.

18. The method according to claim 13 and wherein the metadata comprises a usage rule governing the usage of the content item.

19. The method according to claim 13 and wherein the ECP hash value and the metadata comprised in the data control object have been digitally signed.

20. The method according to claim 19 and wherein the cryptographic integrity data comprises the digital signature of the ECP hash value and the metadata.

21. The method according to claim 13 and wherein the ECP hash value and the metadata comprised in the data control object have been encrypted.

22. The method according to claim 21 and wherein the encrypted ECP hash value and the metadata have been encrypted according to a key, the key comprising a secret shared with the sender of the received data control object.

23. The method according to claim 21 and wherein the cryptographic integrity data comprises a reference to the shared secret.

24. The method according to claim 21 and wherein the using the cryptographic integrity data to cryptographically verify the ECP hash value and the metadata comprises using the key to decrypt the encrypted ECP hash value and metadata.

25. The method according to claim 21 and wherein the cryptographic hash function comprises one of: SHA-1; SHA-2; and SHA-3 candidate function.

26. A system for associating metadata with an encrypted content item, the system comprising:
a metadata receiver operative to receive metadata for association with a content item;
an entitlement control packet (ECP) receiver operative to receive an ECP uniquely associated with at least one portion of the encrypted content item;
a cryptographic engine operative to apply a cryptographic hash function to the ECP, thereby generating an ECP hash value;
a processor operative to combine the ECP hash value with the metadata, thereby creating a data control object;
a second cryptographic engine which performs a cryptographic operation on the data control object, thereby generating cryptographic integrity data; and
a second processor which joins the cryptographic integrity data to the data control object after the cryptographic operation.

27. A system for content utilization, the system comprising:
a content receiver operative to receive an encrypted content item;
an entitlement control packet (ECP) receiver operative to receive an ECP uniquely associated with at least one portion of the encrypted content item;
a data control object receiver operative to receive a data control object , the data control object comprising:
an ECP hash value;
metadata; and
cryptographic integrity data;
a cryptographic engine operative to use the cryptographic integrity data to cryptographically verify the integrity of the data control object;
a second cryptographic engine operative to apply a cryptographic hash function to the received ECP, thereby generating a second ECP hash value;
a comparing processor operative to compare the second ECP hash value with the received ECP hash value; and
a metadata processor operative to perform metadata processing if the result of the comparing is positive, thereby assuring the metadata cryptographically corresponds to the content item,
wherein usage of the content item by the recipient is dependent on both a validation of the ECP hash value and a validation of the cryptographic integrity data.
